(19) United States
(12) Patent Application Publication
(10) Pub. No.: US 2022/0211205 A1
(43) Pub. Date: Jul. 7, 2022

(54) FROZEN FOOD HEATING APPARATUS

(71) Applicant: Novel Food (Suzhou) Co., Ltd., Wujiang Suzhou, Jiangsu (CN)

(72) Inventor: Wen-Chung LEE, Wujiang Suzhou, Jiangsu (CN)

(73) Assignee: Novel Food (Suzhou) Co., Ltd., Wujiang Suzhou, Jiangsu (CN)

(21) Appl. No.: 17/610,684

(22) PCT Filed: Apr. 24, 2020
(86) PCT No.: PCT/CN2020/086571

§ 371 Date: Nov. 11, 2021

(30) Foreign Application Priority Data
May 24, 2019 (CN) 201910438007.4

(51) Int. Cl. A47J 27/04; A23L 5/10; A23L 3/365; A47J 27/21

(52) U.S. Cl. CPC A47J 27/04; A23L 5/13; A47J 2027/043; A47J 27/21166; A23L 3/365

(57) ABSTRACT

A frozen food heating apparatus is disclosed, which includes a boiler body, a water tank in communication with the boiler body, and a container for containing food, a spray nozzle in communication with both the boiler body and the water tank being provided above the container, where a first solenoid valve or an electric ball valve is provided on a connection pipeline between the water tank and the spray nozzle, the spray nozzle is in communication with an upper end of the boiler body and a second solenoid valve is provided on a connection pipeline, and the water tank is in communication with the lower end of the boiler body and a third solenoid valve is provided on a connection pipeline.

### FIELD

The disclosure relates to a frozen food heating apparatus, and belongs to the technical field of food processing devices.

### BACKGROUND

For frozen foods such as frozen noodles, defrosting noodles directly with hot water may cause incomplete defrosting and result in poor taste, while for completely defrosting, a relatively long time would be required, which may result in over soft noodles. Therefore, people have developed a method of using steam to defrost the noodles and then inject hot water or hot soup (including soup bases). Steam would release a lot of condensation heat in a short time during the process of condensing into water, so that such a method can effectively shorten the heating time.

However, in currently known machines, steam and hot water (soup) are both processed separately. A steam module would be provided with a heater for the steam module, and a hot water module would be provided with a heater for the hot water module. Different control circuits, heating spaces, and safety mechanisms are needed for two heaters, and both the cost and the required space would be higher.

### SUMMARY

The technical problem to be solved by the disclosure is to provide a frozen food heating apparatus, which is a food heating apparatus with steam and hot water provided only using one heater.

To solve the technical problem above, the technical solution adopted in the disclosure is to provide a frozen food heating apparatus, which includes a boiler body, a water tank in communication with the boiler body, and a container for containing food, a spray nozzle in communication with both the boiler body and the water tank being provided above the container, where a first solenoid valve or an electric ball valve is provided on a connection pipeline between the water tank and the spray nozzle, the spray nozzle is in communication with the upper end of the boiler body and a second solenoid valve is provided on a connection pipeline, and the water tank is in communication with the lower end of the boiler body and a third solenoid valve is provided on a connection pipeline.

In the frozen food heating apparatus, the water tank is also in communication with the upper end of the boiler body through a connection pipeline, and a fourth solenoid valve is provided on the connection pipeline.

In the frozen food heating apparatus, a spray nozzle cleaning apparatus is further provided on the spray nozzle, the spray nozzle cleaning apparatus is in communication with the upper end of the boiler body through a connection pipeline, and a fifth solenoid valve is provided on the connection pipeline.

In the frozen food heating apparatus, an inner wall of the water tank is coated with a thermal insulating material layer.

In the frozen food heating apparatus, a heater, a pressure gauge, and a boiler water level gauge are provided in the boiler body, and the boiler body is also in communication with a water bucket through a water pump.

In the frozen food heating apparatus, a tank water level gauge is provided in the water tank.

In the frozen food heating apparatus, a second connection pipeline is also provided between the spray nozzle and the upper end of the boiler body, and a sixth solenoid valve is provided on the connection pipeline.

In the frozen food heating apparatus, a connection pipeline is provided between the spray nozzle and an air inlet of the first solenoid valve, and a seventh solenoid valve is provided on the connection pipeline.

The beneficial effects of the disclosure are that:

1. By heating water in the boiler body, steam and hot water coexist in the boiler body. On/off time of the steam and hot water is controlled through solenoid valves on different pipelines, so that food can be heated by steam and hot water using only one heater.

2. The water level and steam pressure in the boiler body are controlled through a water level gauge, a pressure gauge, etc. to ensure that the device can operate normally.

3. Adjusting a steam enter amount at different heating stages would prevent the cracking of a thermal sealing film, while ensuring that the food is completely heated.

### BRIEF DESCRIPTION OF THE DRAWINGS

FIG. 1 is a first schematic structural diagram of a first embodiment of the disclosure.

FIG. 2 is a second schematic structural diagram of the first embodiment of the disclosure.

FIG. 3 is a third schematic structural diagram of the first embodiment of the disclosure.

FIG. 4 is a schematic structural diagram of a second embodiment of the disclosure.

FIG. 5 is a schematic structural diagram of a third embodiment of the disclosure.

### DETAILED DESCRIPTION

The disclosure is further explained below by combining with the specific embodiments.

### Embodiment 1

As shown in FIG. 1, a frozen food heating apparatus includes a boiler body 10, a water tank 30 in communication with the boiler body 10, and a container 20 for containing food 21, a spray nozzle 60 in communication with both the boiler body 10 and the water tank 30 being provided above the container 20, where a first solenoid valve 1 is provided on a connection pipeline between the water tank 30 and the spray nozzle 60, the spray nozzle 60 is in communication with an upper end of the boiler body 10 and a second solenoid valve 2 is provided on a connection pipeline, and the water tank 30 is in communication with the lower end of the boiler body 10 and a third solenoid valve 3 is provided on a connection pipeline. In general, the water tank 30 is an open space having a pressure of about one atmosphere, and the boiler body 10 is a sealed space when pipelines connected to the outside are sealed.

A heater 11, a pressure gauge 12, and a boiler water level gauge 13 are provided in the boiler body 10, and the boiler body 10 is also in communication with a water bucket 50 through a water pump 40. A tank water level gauge 31 is provided in the water tank 30. A second connection pipeline is also provided between the spray nozzle 60 and the upper end of the boiler body 10, and a sixth solenoid valve 6 is provided on the connection pipeline.

When starting heating, the first solenoid valve 1 is closed and the second solenoid valve 2 is opened through a controller, so that the steam produced by heating is injected into a food container through a flow passage and the spray nozzle; the third solenoid valve 3 is opened at the same time or after the second solenoid valve 2 is opened, and water in the boiler body 10 is heated by the heater 11, such that the internal pressure of the boiler body 10 is greater than the internal pressure of the water tank 30, the hot water in the boiler body flows into the water tank 30, until the tank water level gauge 31 senses that the water level reaches a set value, and the controller controls the third solenoid valve 3 to close. After the steam heating ends, the controller closes the second solenoid valve 2 and opens the first solenoid valve 1 so that water in the water tank 30 flows out of the spray nozzle 60 under the action of gravity, and after the water injection is completed, the controller closes the first solenoid valve 1. Preferably, the spray nozzle 60 is directly below the water tank 30, and the pipeline connecting the spray nozzle 60 to the water tank 30 through the first solenoid valve 1 forms a straight pipeline to ensure a smooth water injection process from the water tank 30 to the food.

To solve the problem of heat loss of hot water from the water tank, the inner wall of the water tank 30 is coated with a heat insulating material layer, preferably with a Teflon layer. Teflon has a relatively low thermal conductivity and a very low coefficient of friction at the same time, thereby enabling discharge to be more thorough.

The discharged hot water is mainly used as noodle soup. Soup bases are placed in the food container from the beginning, and are made into a ready-made noodle soup after being mixed with the hot water. However, hot water can also be used for cleaning the spray nozzle. In this case, not all the water in the water tank 30 will be injected into the food container. After the food container is removed, the controller opens the first solenoid valve 1 again to clean the inner wall of the spray nozzle with the remaining hot water.

The pressure in the boiler body is measured by the pressure gauge 12, and when the pressure reaches a set value, the controller controls the heater 11 to stop heating to prevent the pressure in the boiler body 10 from being too high. The water level in the boiler body is measured using the boiler water level meter 13, and when the water level is too low, water is injected through the water pump to ensure the normal operation of the device.

Generally, the packaging method for this kind of frozen noodles is to put frozen noodles and condiments in a plastic bowl, and then seal the top of the bowl with a thermal sealing film to prevent food leakage or external contamination during storage or transportation. During heating, the thermal sealing film is directly punctured using the spray nozzle, and then steam is injected from the spray nozzle.

However, when the steam is injected for a period of time, the temperature of the food itself increases, and the surface of the food would be covered with a condensed water layer, the heat release efficiency of the steam is thus decreased. As a result, a large amount of steam cannot be smoothly condensed into water, and still flows in the container in a state of steam. At this time, since the container is still almost in a sealed state except for the hole punctured by the spray nozzle, the pressure would rise rapidly. In fact, the thermal sealing film would crack after bulging, and the condiments or excess water would be ejected from a crack, contaminating the space for heating and making it difficult to clean.

However, if the steam injection is stopped before the thermal sealing film cracks, it would be easily found that the noodles are heated incompletely, and some noodles are still not defrosted.

Therefore, in the present embodiment, a second connection pipeline is provided between the spray nozzle 60 and the upper end of the boiler body 10, and a sixth solenoid valve 6 is provided on the connection pipeline, as shown in FIG. 1. When the steam heating starts, the second solenoid valve 2 and the sixth solenoid valve 6 are opened at the same time, and after a period of time, the controller closes the sixth solenoid valve 6 and only the second solenoid valve 2 is opened. After a period of time, the controller also closes the second solenoid valve 2, and at this time, the heating steam flow passages are all closed. The duration when the second solenoid valve 2 and the sixth solenoid valve 6 are opened at the same time is defined as a first stage, and the duration when only the second solenoid valve 2 is opened is defined as a second stage. The durations of the first and second stages are determined by test results, and usually last 5-15 seconds, respectively, and different durations can be set for different types of noodles.

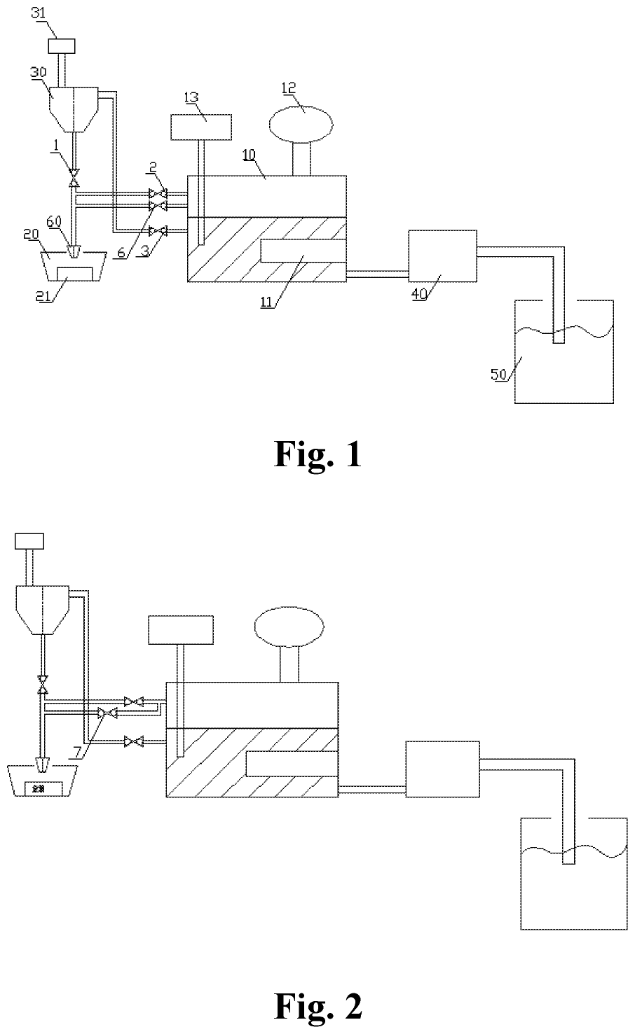

A multi-stage heating structure may also be the structure shown in FIG. 2. A connection pipeline is provided between the spray nozzle 60 and the air inlet of the first solenoid valve 1, and a seventh solenoid valve 7 is provided on the connection pipeline. If the boiler body 10 has only one steam outlet, a pipeline can be connected to the steam outlet and then branched, and the second solenoid valve 2 and the seventh solenoid valve 7 are disposed on branched pipes, which are finally connected to the spray nozzle.

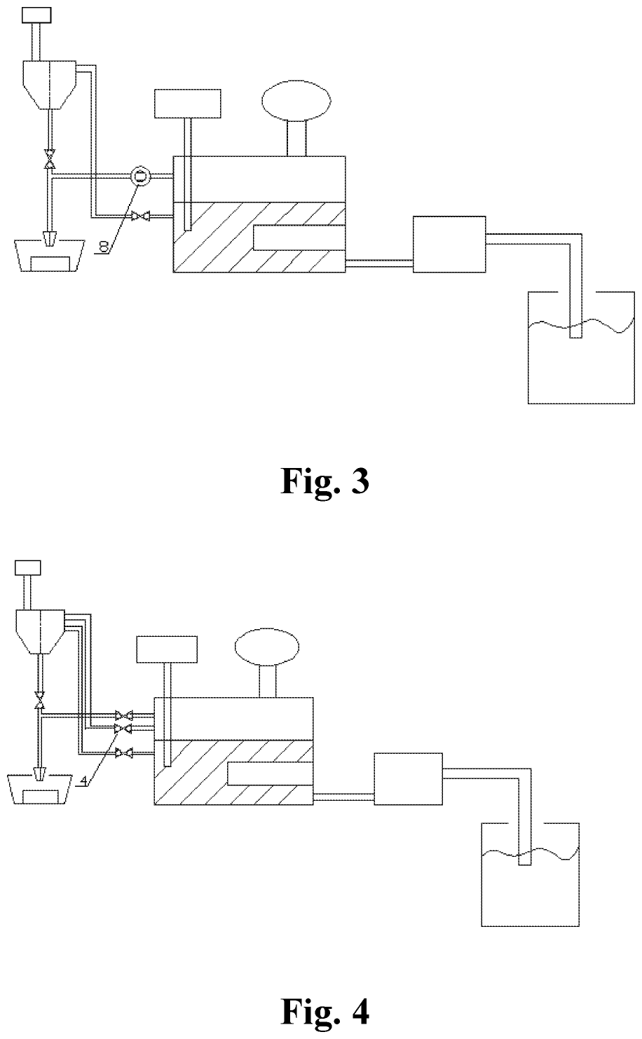

The multi-stage heating structure may also be as the structure shown in FIG. 3. An electric ball valve 8 is provided on the connection pipeline between the water tank 30 and the spray nozzle 60. In the first stage, the controller controls the electric ball valve to rotate to an angle with a larger flow rate (a pipeline cross-sectional area), and in the second stage, the controller controls the electric ball valve to rotate to an angle with a smaller flow rate but not completely closed.

Although the embodiment above only mentions two stages, but in fact, multiple stages are also feasible. The number of holes on a boiler and the number of solenoid valves applied changes along with the number of stages, or the electric valve has multiple rotation angles. Moreover, in the present embodiment, an electric ball valve is used, but in fact, it is also feasible to use an electric butterfly valve or other electric control valves that can change the flow rate.

### Embodiment 2

As shown in FIG. 4, a frozen food heating apparatus includes a boiler body 10, a water tank 30 in communication with the boiler body 10, and a container 20 for containing food 21, a spray nozzle 60 in communication with both the boiler body 10 and the water tank 30 being provided above the container 20, where a first solenoid valve 1 is provided on a connection pipeline between the water tank 30 and the spray nozzle 60, the spray nozzle 60 is in communication with the upper end of the boiler body 10 and a second solenoid valve 2 is provided on a connection pipeline, and the water tank 30 is in communication with the lower end of the boiler body 10 and a third solenoid valve 3 is provided on a connection pipeline.

A heater 11, a pressure gauge 12, and a boiler water level gauge 13 are provided in the boiler body 10, and the boiler body 10 is also in communication with a water bucket 50 through a water pump 40. A tank water level gauge 31 is provided in the water tank 30.

The water tank 30 is also in communication with the upper end of the boiler body 10 through a connection pipeline, and a fourth solenoid valve 4 is provided on the connection pipeline.

If the food heating process is not performed for a period of time, the temperature in the water tank would gradually drop to a normal level. When the hot water is injected next time, part of the heat of the hot water would be absorbed by the water tank, and the temperature of the hot water injected into the food container would not reach an ideal temperature. To solve this problem, a flow passage for delivering steam is added between the boiler body and the water tank, and the on/off of the flow passage is controlled by the fourth solenoid valve 4. Before hot water is delivered from the boiler body to the water tank, the controller first opens the fourth solenoid valve 4. At this time, a certain amount of steam flows out of the boiler body, and when the steam flows into the water tank, the temperature of the water tank increases to achieve a preheating effect.

### Embodiment 3

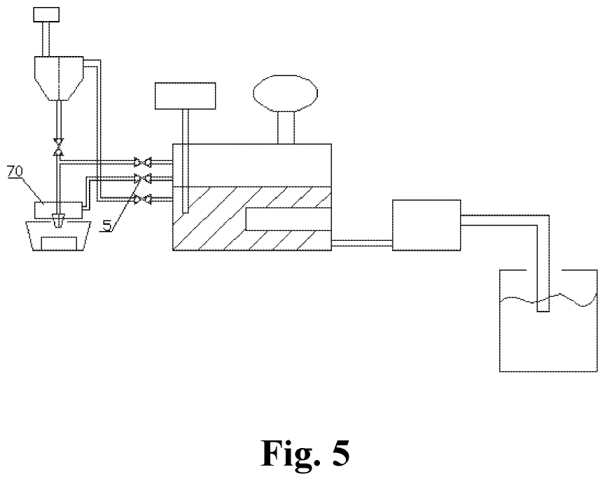

As shown in FIG. 5, a frozen food heating apparatus includes a boiler body 10, a water tank 30 in communication with the boiler body 10, and a container 20 for containing food 21, a spray nozzle 60 in communication with both the boiler body 10 and the water tank 30 being provided above the container 20, where a first solenoid valve 1 is provided on a connection pipeline between the water tank 30 and the spray nozzle 60, the spray nozzle 60 is in communication with the upper end of the boiler body 10 and a second solenoid valve 2 is provided on a connection pipeline, and the water tank 30 is in communication with the lower end of the boiler body 10 and a third solenoid valve 3 is provided on a connection pipeline.

A heater 11, a pressure gauge 12, and a boiler water level gauge 13 are provided in the boiler body 10, and the boiler body 10 is also in communication with a water bucket 50 through a water pump 40. A tank water level gauge 31 is provided in the water tank 30.

A spray nozzle cleaning apparatus 70 is further provided on the spray nozzle 60, the spray nozzle cleaning apparatus 70 is in communication with the upper end of the boiler body 10 through a connection pipeline, and a fifth solenoid valve 5 is provided on the connection pipeline.

During heating, the spray nozzle may be contaminated with food. To solve this problem, a spray nozzle cleaning apparatus 70 can be added, the spray nozzle cleaning apparatus 70 is connected to the boiler body, and the on/off of the flow passage therebetween is controlled by the fifth solenoid valve 5. After the heating process is completed, the controller opens the fifth solenoid valve 5, and steam or hot water is sprayed from the spray nozzle cleaning apparatus to achieve the effect of cleaning the spray nozzle.

In the embodiment above, a pressure gauge is used for monitoring the state of the boiler body, but because there is a certain relationship between the saturation steam pressure of water and the boiling temperature, it is theoretically feasible to perform monitoring with a thermometer.

In addition, to solve the problem of liquid level fluctuations in the water tank, a shower head structure can be mounted at the outlet of the flow passage for injecting water from the boiler body to the water tank to absorb part of the kinetic energy of the water, so that the water injection force is reduced. In another method, a pressure reducing valve can be added in the flow passage for injecting water from the boiler body to the water tank, so as to reduce the water injection force.

In conclusion, the disclosure provides a frozen food heating apparatus, which is capable of providing both steam and hot water by using only one heater.

The basic principles, main features, and advantages of the disclosure are shown and described above. Persons of ordinary skill in the art should know that the disclosure is not limited by the embodiments described above, and described above in the description and the embodiments are only principles of the disclosure. Several improvements and modifications can be made within the spirit and scope of the disclosure, and these improvements and modifications should also be regarded as falling within the scope of protection of the disclosure. The scope of protection claimed by the disclosure is defined by the appended claims and their equivalents.

1. A frozen food heating apparatus, comprising a boiler body (10), a water tank (30) in communication with the boiler body (10), and a container (20) for containing food (21), wherein
a spray nozzle (60) in communication with both the boiler body (10) and the water tank (30) is provided above the container (20),
a first solenoid valve (1) or an electric ball valve (8) is provided on a connection pipeline between the water tank (30) and the spray nozzle (60), the spray nozzle (60) is in communication with an upper end of the boiler body (10) and a second solenoid valve (2) is provided on a connection pipeline, and the water tank (30) is in communication with a lower end of the boiler body (10) and a third solenoid valve (3) is provided on a connection pipeline.

2. The frozen food heating apparatus according to claim 1, wherein,
the water tank (30) is also in communication with the upper end of the boiler body (10) through a connection pipeline, and a fourth solenoid valve (4) is provided on the connection pipeline.

3. The frozen food heating apparatus according to claim 1, wherein,
a spray nozzle cleaning apparatus (70) is further provided on the spray nozzle (60), the spray nozzle cleaning apparatus (70) is in communication with the upper end of the boiler body (10) through a connection pipeline, and a fifth solenoid valve (5) is provided on the connection pipeline.

4. The frozen food heating apparatus according to Claim 1, wherein,
an inner wall of the water tank (30) is coated with a thermal insulating material layer.

5. The frozen food heating apparatus according to Claim 1, wherein,
a heater (11), a pressure gauge (12), and a boiler water level gauge (13) are provided in the boiler body (10), and the boiler body (10) is also in communication with a water bucket (50) through a water pump (40).

6. The frozen food heating apparatus according to claim 5, wherein,
a tank water level gauge (31) is provided in the water tank (30).

7. The frozen food heating apparatus according to claim 5, wherein,
a second connection pipeline is also provided between the spray nozzle (60) and the upper end of the boiler body (10), and a sixth solenoid valve (6) is provided on the connection pipeline.

8. The frozen food heating apparatus according to claim 5, wherein,
a connection pipeline is provided between the spray nozzle (60) and an air inlet of the first solenoid valve (1), and a seventh solenoid valve (7) is provided on the connection pipeline.
